(19) United States
(12) Patent Application Publication
(10) Pub. No.: US 2022/0006804 A1
(43) Pub. Date: Jan. 6, 2022

(54) GATEWAY AND PROXY FOR VEHICLE HEAD UNIT CERTIFICATE VALIDATION

(71) Applicant: TOYOTA MOTOR NORTH AMERICA, INC., Plano, TX (US)

(72) Inventors: Narayanan P. Sivaraman, Austin, TX (US); Sandhya Kodali, Frisco, TX (US)

(73) Assignee: TOYOTA MOTOR NORTH AMERICA, INC.

(21) Appl. No.: 16/920,491

(22) Filed: Jul. 3, 2020

(51) Int. Cl. H04L 29/06; H04L 29/08; H04W 12/00; H04W 12/08; H04W 4/40

(52) U.S. Cl. CPC H04L 63/0823; H04L 63/0428; H04L 63/166; H04L 63/061; H04W 4/40; H04W 12/0017; H04W 12/003; H04W 12/0802; H04L 67/02

(57) ABSTRACT

Disclosed is a client-server system. The server includes a processor, an application layer, and a transport layer. The client device is associated with a vehicle, and communicates with the server via a wireless communication link. One or more services are accessible on the server by the client device over the wireless communication link, through a secure communication session established between the server and the client device over the wireless communication link. The secure communication session is established on the transport layer of the server based at least in part on a communication protocol, an encryption key, and a credential uniquely associated with the vehicle and transmitted by the client device. A gateway process running on the application layer of the server is configured to validate the credential after it is received over the wireless communication link, and the encryption key is then provided to the client device based at least in part on the validated credential.

### TECHNICAL FIELD

The subject matter described herein relates to devices and methods for validating a digital certificate for a vehicle head unit. This technology has particular but not exclusive utility for cars and trucks.

### BACKGROUND

Modern vehicles often include a head unit (HU) to permit a user to access different functions of the vehicle (e.g., audio controls, environmental controls) and different external services. However, currently there are not suitable security measures for authorized access to remote services. It is therefore desirable to provide a system for validating a vehicle's right to access services.

The information included in this Background section of the specification, including any references cited herein and any description or discussion thereof, is included for technical reference purposes only and is not to be regarded as limiting.

### SUMMARY

A vehicle may communicate with a remote server to access services. Services may include for example navigation, concierge, user profile management, as well as e-commerce operations such as audiovisual content purchases, remote fuel purchases, upgrade purchases, etc., and may be provided by a server (e.g., a web server) that is remote from the vehicle and accessed via a network through a client-server architecture. Authentication may take place in three layers: asset-based authentication (e.g., associated with the vehicle), knowledge-based authentication (e.g., user passwords, biometrics, etc.), and authorization (e.g., whether or the customer purchased access to the service).

Vehicle networks can implement Online Certificate Status Protocol (OCSP) for authenticating vehicles requesting such services. With OSCP, communications may be secured using a Transport Layer Security (TLS) session connecting the client and server. TLS is a security protocol that uses public-key encryption certificates for authentication between two parties, and is for example the basis for Hypertext Transfer Protocol Secure (HTTPS), the protocol for exchanging private information over the World Wide Web (e.g., credit card numbers, private user data, etc.).

The vehicle's right to access secure services via TLS may be validated by an exchange of digital certificates. With OSCP, the client validates the server's certificate by sending the certificate's serial number to a third-party certifying authority (CA). The server validates the client's certificate by the same process, and either side may refuse the connection if the other side's certificate is reported as revoked. In a client-server architecture, this “handshake” process may occur at a “Transport Layer” on both the client side and the server side, e.g., Layer 4 of the Open Systems Interconnection (OSI) model of network communication.

However, in some instances, the above noted OCSP certificate validation method may not be able to identify and classify certificate serial numbers and/or vehicle IDs as invalid during the TLS handshake process, which is a security gap that increases vulnerability of server back-end services to attack. Furthermore, in the case of vehicle head units (HU's) securely accessing remote services, an OSCP architecture may take an excessive amount of time, as both the client and the server must communicate with the CA before the TLS session can be established.

As such, disclosed is a head unit gateway that runs on an Application Layer (e.g., OSI Layer 7) of the server, and provides rapid authentication of the vehicle head unit's digital certificate. The head unit sends its certificate data to the head unit gateway as a header (e.g., a hypertext transfer protocol (HTTP) header), and the head unit gateway validates the certificate data, and then passes the validation on to the server as though validation had occurred at the Transport Layer (e.g., OSI layer 4). This simplified handshake process permits the server to validate the HU, to reject connections from rogue certificates, and to form valid TLS connections with the HU, without the need to query a Certificate Authority in real time.

The present disclosure thus presents a hybrid Layer 4/Layer 7 approach to vehicle network security, particularly in relation to vehicle IDs accessing vehicle services. At Layer 7, client certificates are validated by a head unit (HU) gateway running on the server. The head unit gateway may also be thought of or referred to as application proxy logic, or a proxy server. A proxy server is an application or device that acts as an intermediary in client-server requests (e.g., requests to upload data from a client application to a server application, or to download data from a server application to a client application). The head unit gateway maintains a Certificate Revocation List (CRL), which is a “blacklist” of rogue/invalid certificates that includes vehicle IDs associated with rogue or invalid certificates. If the head unit gateway determines the certificate information is invalid, the HU gateway terminates the Layer 4 connection (e.g., the TLS session) and prevents that particular vehicle ID from accessing vehicle services on the remote server. This may minimize the exposure of the services to malicious activities, and may also reduce the overhead associated with real-time OCSP validation and thus speed establishment of TLS sessions.

The head unit gateway disclosed herein has particular, but not exclusive, utility for managing the client-server communication of cars and trucks with remote services. One general aspect of the head unit gateway includes a server including a processor, an application layer, and a transport layer; a client device associated with a vehicle; a wireless communication link between the server and the client device; a credential uniquely associated with the vehicle, where the credential is configured to be transmitted by the client device using a communication protocol and received by the server over the wireless communication link; a gateway process running on the application layer of the server and configured to validate the credential after it is received over the wireless communication link; an encryption key provided to the client device based at least in part on the validated credential; a secure communication session established between the server and the client device over the wireless communication link, where the secure communication session is established on the transport layer of the server based at least in part on the communication protocol and the encryption key; and one or more services accessible on the server by the client device over the wireless communication link through the secure communication session. Other embodiments of this aspect include corresponding computer systems, apparatus, and computer programs recorded on one or more computer storage devices, each configured to perform the actions of the methods.

In some implementations, the credential includes a public key encryption certificate. In some implementations, the credential further includes a vehicle ID. In some implementations, the communication protocol is a hypertext transmission protocol (HTTP). In some implementations, the secure communication session is a transport layer security (TLS) session. In some implementations, the client device includes a head unit of the vehicle. In some implementations, validating the credential includes checking the credential against a list of revoked credentials. In some implementations, the list of revoked credentials is stored locally on the server. In some implementations, the one or more services include at least one of a navigation service, a concierge service, or an e-commerce service. In some implementations, the system further includes the vehicle. Implementations of the described techniques may include hardware, a method or process, or computer software on a computer-accessible medium.

One general aspect includes providing a server including a processor; establishing a wireless communication link between the server and a client device on a vehicle; providing a credential uniquely associated with the vehicle; with the server, receiving the credential from the client device using the wireless communication link and a communication protocol; with a gateway process running on an application layer of the server, validating the credential after it is received over the wireless communication link; with the server, providing an encryption key to the client device based at least in part on the validated credential; a transport layer of the server, establishing a secure communication session between the server and the client device using the wireless communication link, the communication protocol, and the encryption key; and from the server, supplying one or more services to the client device through the secure communication session. Other embodiments of this aspect include corresponding computer systems, apparatus, and computer programs recorded on one or more computer storage devices, each configured to perform the actions of the methods.

In some implementations, the credential includes a public key encryption certificate. In some implementations, the credential further includes a vehicle ID. In some implementations, the communication protocol is a hypertext transmission protocol (HTTP). In some implementations, the secure communication session is a transport layer security (TLS) session. In some implementations, the client device includes a head unit of the vehicle. In some implementations, validating the credential includes checking the credential against a list of revoked credentials, where the list of revoked credentials is stored locally on the server. In some implementations, the one or more services include at least one of a navigation service, a concierge service, or an e-commerce service. Implementations of the described techniques may include hardware, a method or process, or computer software on a computer-accessible medium.

This Summary is provided to introduce a selection of concepts in a simplified form that are further described below in the Detailed Description. This Summary is not intended to identify key features or essential features of the claimed subject matter, nor is it intended to limit the scope of the claimed subject matter. A more extensive presentation of features, details, utilities, and advantages of the head unit gateway, as defined in the claims, is provided in the following written description of various embodiments of the disclosure and illustrated in the accompanying drawings.

### BRIEF DESCRIPTION OF THE DRAWINGS

Illustrative embodiments of the present disclosure will be described with reference to the accompanying drawings, of which:

FIG. 1 is a diagrammatic illustration of a vehicle incorporating a head unit client configured to communicate with a remote head unit gateway in accordance with at least one embodiment of the present disclosure.

FIG. 2 is a diagrammatic illustration, in a block-diagram form, of at least a portion of the head unit client of FIG. 1, in accordance with at least one embodiment of the present disclosure.

FIG. 3 is a diagrammatic illustration of a client-server architecture that permits a client to communicate securely with a server over a network, according to aspects of the present disclosure.

FIG. 4 is a diagrammatic illustration of a client-server architecture that permits a client to communicate securely with a server over a network, using a head unit gateway, in accordance with at least one embodiment of the present disclosure.

FIG. 5 is a diagrammatic illustration, in block diagram form, of a handshake process between a vehicle head unit and a server that includes a head unit gateway or head unit proxy, in accordance with at least one embodiment of the present disclosure.

FIG. 6 is a diagrammatic illustration of communication between a head unit and a plurality of services, in accordance with at least one embodiment of the present disclosure.

FIG. 7 is a diagrammatic illustration of communication between a head unit and a service, in accordance with at least one embodiment of the present disclosure.

FIG. 8 is a diagrammatic illustration of communication between a head unit and a service, in accordance with at least one embodiment of the present disclosure.

FIG. 9 is a diagrammatic illustration, in a block-diagram form, of a processor circuit, according to embodiments of the present disclosure.

### DETAILED DESCRIPTION

In accordance with at least one embodiment of the present disclosure, a head unit gateway is disclosed that streamlines and improves the process for digital certificate validation in vehicle networks. A vehicle may include a client process that communicates over a network with a remote server, to access external or remote vehicle services such as navigation, concierge, and e-commerce. Vehicle networks can implement Online Certificate Status Protocol (OCSP) for authenticating vehicles requesting vehicle services (i.e., to check whether a vehicle's digital certificate has been revoked). With OSCP, communications may be secured by an encrypted two-way communication link using a Transport Layer Security (TLS) session operating at Open Systems Interconnection (OSI) Layer 4 (the Transport Layer). TLS helps protect both the vehicle and the server from attack by rogue agents, by ensuring that each side is communicating with a valid entity rather than, for example, a “man in the middle” attacker. The vehicle's right to access secure services via TLS may be validated at the time of initialization by the exchange of digital certificates—one certificate uniquely associated with the client or vehicle and a second certificate uniquely associated with the server. With OSCP, the client validates the server's certificate by sending the certificate's serial number to a third-party certifying authority (CA), which checks the serial number against a current “blacklist” of revoked certificates. The server validates the client's certificate by the same process, and either side may refuse the connection if the other side's certificate is reported by the CA as invalid or revoked. Once both certificates have been deemed valid, the client and server exchange a mutual encryption key, and can then begin exchanging encrypted data. In a client-server architecture, this “handshake” process may occur at a “Transport Layer” on both the client side and the server side, e.g., Layer 4 of the Open Systems Interconnection (OSI) model of network communication.

However, in some instances, the above noted OCSP certificate validation method may not be able to identify and classify certificate serial numbers as invalid during the TLS handshake process, which is a security gap that increases vulnerability of server back-end services to attack (e.g., hacking). Furthermore, in the case of millions of vehicle head units (HU's) securely accessing remote services, an OSCP architecture could then require millions of real-time communications between the server and the CA, thus placing an increased demand on communications networks as well as potentially slowing down the establishment of valid TLS sessions between the server and the millions of vehicles, and leaving the server open to attack by an agent posing as, or blocking access to, the certificate authority. In a low-trust or zero-trust environment, this may prevent a TLS connection from being formed. In a high-trust environment, this may encourage the server to form a connection whose certificate has not been validated.

Disclosed is a head unit gateway or proxy server that runs on the Application Layer (e.g., OSI Layer 7) of the server, and provides real-time authentication of a digital certificate associated with the vehicle. The head unit of a vehicle sends its certificate data and vehicle ID to the head unit gateway as a header (e.g., a hypertext transfer protocol (HTTP) header), and the head unit gateway checks the certificate's serial number and/or the vehicle ID against a locally maintained blacklist. This blacklist may for example be obtained or updated from the CA on a daily basis. This simplified handshake process permits the server to validate the HU, to reject connections from rogue certificates, and to form valid TLS connections with the HU, without requiring real-time communication with the CA.

This vehicle network security setup, involving a hybrid Layer 4 (Transport Layer)/Layer 7 (Application Layer) approach, may assist in preventing expired or invalid vehicle IDs from accessing vehicle services. Unlike OSCP, this modified approach takes certificate validation from Layer 4 (where the TLS session occurs) to Layer 7. At Layer 7, client certificates are validated by a head unit (HU) gateway (e.g., an application proxy logic or proxy server module) running on the server hardware. The head unit gateway proactively manages and maintains a blacklist of rogue or invalid certificates and/or vehicle IDs associated with the bad certificates. In some embodiments, the head unit gateway may delegate the maintenance of the blacklist to another system or repository. The head unit gateway thus does not rely on the Transport Layer (e.g., an OSCP communication with a Certificate Authority) for certificate validation of a vehicle ID.

The head unit gateway listens for TLS sessions and takes the certificate validation process “offline” (i.e., off of Layer 4) from the server's point of view. From the client's point of view (e.g., the point of view of a vehicle's head unit), the process may still occur over the vehicle network. If the head unit gateway determines the client's certificate information is invalid, the HU gateway terminates the Layer 4 connection (i.e., the TLS session) and prevents that particular vehicle ID from accessing vehicle services. In some embodiments, this prevents a head unit from proceeding to access server functions due to invalid certificates and minimizes services exposure to malicious activities. In some embodiments, moving certificate validation to the head unit gateway eliminates overhead associated with real-time OCSP certificate revocation checks, and thus reduces the time required to establish valid TLS sessions. In some embodiments, the head unit gateway may be activated upon the HU receiving a push notification from a server that includes valid certificate information.

The present disclosure aids substantially in establishing valid, secure connections between a vehicle and a server, by improving the ability of the server to validate a digital certificate associated with the vehicle's ID. Implemented on a server that includes a processor, the head unit gateway disclosed herein provides a practical, faster alternative to Online Certificate Status Protocol (OSCP), that also keeps track invalid vehicle IDs as well as invalid digital certificates. This improved Transport Layer Security functionality transforms a process requiring remote communication between three geographically separated machines (the vehicle head unit, the remote server, and the Certificate Authority) into a simplified handshake between only the HU and the server, without the normally routine need for the server to consult the CA in real time. This unconventional approach improves the functioning of the server, by reducing the amount of time and computational overhead required to determine whether a vehicle head unit's request for services is valid, and also improves the functioning of the vehicle, by improving the security and speed of remote vehicle services.

The head unit gateway may be implemented on a server that provides services to the head unit, and may be operated by a control process executing on a processor whose actions vary in response to inputs made by the user through the head unit. In that regard, the control process performs certain specific operations in response to different inputs or selections made at different times, by the user operating the head unit. Certain structures, functions, and operations of the processor, sensors, and user input systems enable novel features or aspects of the present disclosure with particularity.

These descriptions are provided for exemplary purposes only, and should not be considered to limit the scope of the head unit gateway. Certain features may be added, removed, or modified without departing from the spirit of the claimed subject matter.

For the purposes of promoting an understanding of the principles of the present disclosure, reference will now be made to the embodiments illustrated in the drawings, and specific language will be used to describe the same. It is nevertheless understood that no limitation to the scope of the disclosure is intended. Any alterations and further modifications to the described devices, systems, and methods, and any further application of the principles of the present disclosure are fully contemplated and included within the present disclosure as would normally occur to one skilled in the art to which the disclosure relates. In particular, it is fully contemplated that the features, components, and/or steps described with respect to one embodiment may be combined with the features, components, and/or steps described with respect to other embodiments of the present disclosure. For the sake of brevity, however, the numerous iterations of these combinations will not be described separately.

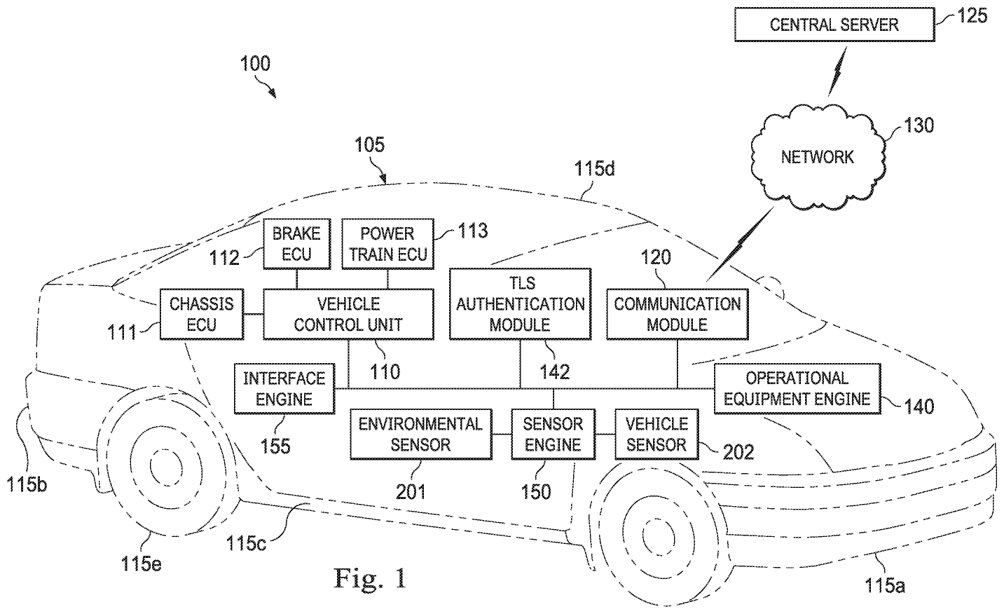

FIG. 1 is a diagrammatic illustration of a vehicle incorporating a head unit client configured to communicate with a remote head unit gateway in accordance with at least one embodiment of the present disclosure. In an example, head unit client is referred to by the reference numeral 100 and includes a vehicle 105, such as an automobile, and a vehicle control unit 110 located on the vehicle 105. The vehicle 105 may include a front portion 115a (including a front bumper), a rear portion 115b (including a rear bumper), a right side portion 115c (including a right front quarter panel, a right front door, a right rear door, and a right rear quarter panel), a left side portion 115d (including a left front quarter panel, a left front door, a left rear door, and a left rear quarter panel), and wheels 115e. A communication module 120 may be operably coupled to, and adapted to be in communication with, the vehicle control unit 110. The communication module 120 may be adapted to communicate wirelessly with a central server 125 via a network 130 (e.g., a 3G network, a 4G network, a 5G network, a Wi-Fi network, or the like). The central server 125 may provide information and services including but not limited to location/mapping, concierge service, user profile maintenance, and e-commerce (e.g., purchase of audiovisual content, enablement of vehicle software options, remote fuel purchase, etc.).

An operational equipment engine 140 is operably coupled to, and adapted to be in communication with, the vehicle control unit 110. A sensor engine 150 is operably coupled to, and adapted to be in communication with, the vehicle control unit 110. The sensor engine 150 is adapted to monitor various components of, for example, the operational equipment engine 140. An interface engine 155 is operably coupled to, and adapted to be in communication with, the vehicle control unit 110. In addition to, or instead of, being operably coupled to, and adapted to be in communication with, the vehicle control unit 110, the communication module 120, the operational equipment engine 140, the sensor engine 150, and/or the interface engine 155 may be operably coupled to, and adapted to be in communication with, another of the components via wired or wireless communication (e.g., via an in-vehicle network). In some examples, the vehicle control unit 110 is adapted to communicate with the communication module 120, the operational equipment engine 140, the sensor engine 150, and the interface engine 155 to at least partially control the interaction of data with and between the various components of the vehicle and the head unit client 100.

The term “engine” is meant herein to refer to an agent, instrument, or combination of either, or both, agents and instruments that may be associated to serve a purpose or accomplish a task—agents and instruments may include sensors, actuators, switches, relays, power plants, system wiring, computers, components of computers, programmable logic devices, microprocessors, software, software routines, software modules, communication equipment, networks, network services, and/or other elements and their equivalents that contribute to the purpose or task to be accomplished by the engine. Accordingly, some of the engines may be software modules or routines, while others of the engines may be hardware and/or equipment elements in communication with any or all of the vehicle control unit 110, the communication module 120, the network 130, or a central server 125.

In this example, the vehicle 105 also includes a chassis electronic control unit (ECU) 111 which controls elements of the vehicle's suspension system, a brake ECU 112 which controls the braking system or elements thereof, a power train ECU 113 (variously known as an engine ECU, power plant ECU, motor ECU, or transmission ECU) that controls elements of the motor and drivetrain. The system also includes one or more environmental sensors 201, one or more vehicle sensors 202, and a TLS authentication module 142, the operation of which will be described below.

A reader of ordinary skill in the art will appreciate that other components or arrangements of components may be found in a vehicle 105, and that the same general principles apply to electric vehicles, internal combustion vehicles, and hybrid vehicles. For example, a power train ECU 113 may control both motor and transmission components. Alternatively, a separate motor ECU and transmission ECU may exist, or some functions of a motor ECU or transmission ECU may be performed by the VCU 110.

Before continuing, it should be noted that the examples described above are provided for purposes of illustration, and are not intended to be limiting. Other devices and/or device configurations may be utilized to carry out the operations described herein.

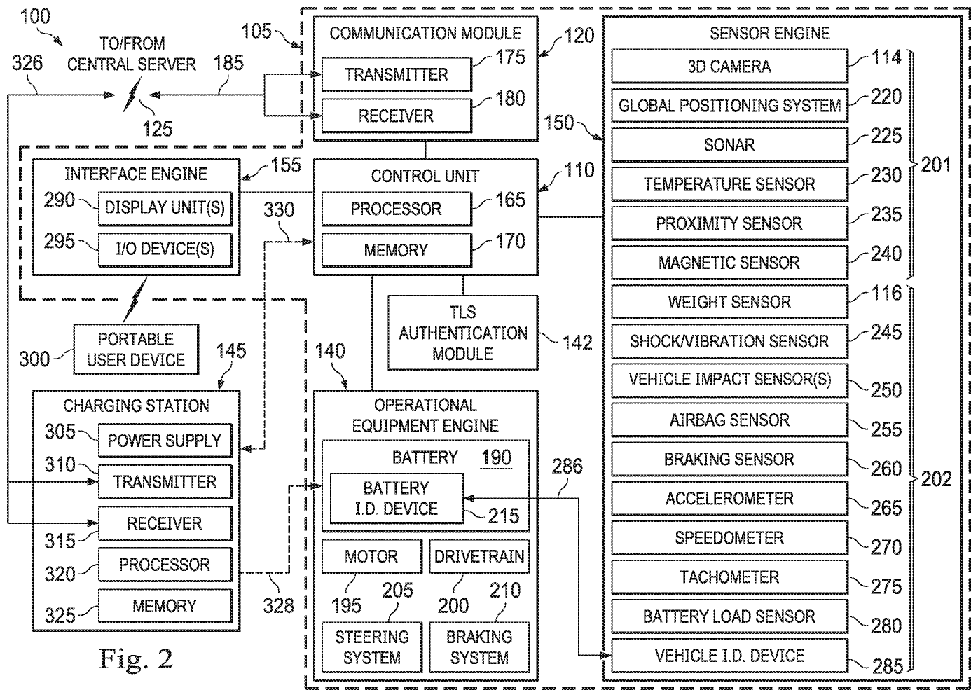

FIG. 2 is a diagrammatic illustration, in a block-diagram form, of at least a portion of the head unit client 100 of FIG. 1, in accordance with at least one embodiment of the present disclosure. It is noted that the components of the vehicle 105 may be located either permanently or temporarily as a part of the vehicle 105. The vehicle control unit (VCU) 110 includes a processor 165 and a memory 170. In some examples, the communication module 120, which is operably coupled to, and adapted to be in communication with, the vehicle control unit 110, includes a transmitter 175 and a receiver 180. In some examples, one or the other of the transmitter 175 and the receiver 180 may be omitted according to the particular application for which the communication module 120 is to be used. In other examples, the transmitter 175 and receiver 180 are combined into a single transceiver that performs both transmitting and receiving functions.

In some examples, the operational equipment engine 140, which is operably coupled to, and adapted to be in communication with, the vehicle control unit 110, includes a plurality of devices configured to facilitate driving of the vehicle 105. In this regard, the operational equipment engine 140 may be designed to exchange communication with the vehicle control unit 110, so as to not only receive instructions, but to provide information on the operation of the operational equipment engine 140. For example, the operational equipment engine 140 may include a vehicle battery 190, a motor 195, a drivetrain 200, a steering system 205, and a braking system 210. In some vehicles, the vehicle battery 190 may provide electrical power to the motor 195 to drive the wheels 115e of the vehicle 105 via the drivetrain 200. In some examples, instead of or in addition to providing power to the motor 195 to drive the wheels 115e of the vehicle 105 via the drivetrain or transmission 200, the vehicle battery 190 provides electrical power to another component of the operational equipment engine 140, the vehicle control unit 110, the communication module 120, the sensor engine 150, the interface engine 155, or any combination thereof. In some examples, the vehicle battery 190 includes a battery identification device 215. In some embodiments, the motor is an internal combustion motor and the battery operates a starter.

In some examples, the sensor engine 150, which is operably coupled to, and adapted to be in communication with, the vehicle control unit 110, includes devices such as sensors, meters, detectors, or other devices configured to measure or sense a parameter related to a driving operation of the vehicle 105. For example, the sensor engine 150 may include a global positioning system 220, a 2D or 3D sonar sensor 225, a 2D or 3D proximity sensor 235, a magnetic sensor 240, a shock/vibration sensor 245, a vehicle impact sensor 250, an airbag sensor 255, a braking sensor 260, an accelerometer 265, a speedometer 270, a tachometer 275, a battery load sensor 280, a vehicle identification device 285, a 2D or 3D camera 114, a weight sensor 116, or any combinations thereof. The sensors or other detection devices may be configured to sense or detect activity, conditions, and circumstances in an area to which the device has access, e.g., conditions inside or outside the vehicle cabin. Sub-components of the sensor engine 150 may be deployed at any operational area where information on the driving of the vehicle 105 may occur. Readings from the sensor engine 150 are fed back to the vehicle control unit 110. Stored and reported performance data may include the sensed data, or may be derived, calculated, or inferred from sensed data. The vehicle control unit 110 may send signals to the sensor engine 150 to adjust the calibration or operating parameters of the sensor engine 150 in accordance with a control program in the vehicle control unit 110. The vehicle control unit 110 is adapted to receive and process performance data from the sensor engine 150 or from other suitable source(s), and to monitor, store (e.g., in the memory 170), and/or otherwise process (e.g., using the processor 165) the received performance data.

The braking sensor 260 is adapted to monitor usage of the vehicle 105's braking system 210 (e.g., an antilock braking system 210) and to communicate the braking information to the vehicle control unit 110. The accelerometer 265 is adapted to monitor acceleration of the vehicle 105 and to communicate the acceleration information to the vehicle control unit 110. The accelerometer 265 may be, for example, a two-axis accelerometer 265 or a three-axis accelerometer 265. In some examples, the accelerometer 265 is associated with an airbag of the vehicle 105 to trigger deployment of the airbag. The speedometer 270 is adapted to monitor speed of the vehicle 105 and to communicate the speed information to the vehicle control unit 110. In some examples, the speedometer 270 is associated with a display unit of the vehicle 105 such as, for example, a display unit of the interface engine 155, to provide a visual indication of vehicle speed to a driver of the vehicle 105. The tachometer 275 is adapted to monitor the working speed (e.g., in revolutions-per-minute) of the vehicle 105's motor 195 and to communicate the angular velocity information to the vehicle control unit 110. In some examples, the tachometer 275 is associated with a display unit of the vehicle 105 such as, for example, a display unit of the interface engine 155, to provide a visual indication of the motor 195's working speed to the driver of the vehicle 105. The battery load sensor 280 is adapted to monitor charging, discharging, and/or overcharging of the vehicle battery 190 and to communicate the charging, discharging, and/or overcharging information to the vehicle control unit 110.

In some examples, the vehicle identification device 285 stores data identifying the vehicle 105 such as, for example, manufacturing information (e.g., make, model, production date, production facility, etc.), vehicle characteristic(s) information, vehicle identification number (“VIN”) information, battery compatibility information, or the like. The vehicle identification device 285 may be adapted to communicate with the battery identification device 215 (or vice versa), as indicated by arrow 286. In some examples, the vehicle identification device 285 and the battery identification device 215 may each communicate with the vehicle control unit 110.

In some examples, the interface engine 155, which is operably coupled to, and adapted to be in communication with, the vehicle control unit 110, includes at least one input and output device or system that enables a user to interact with the vehicle control unit 110 and the functions that the vehicle control unit 110 provides. For example, the interface engine 155 may include a display unit 290 and an input/output (“I/O”) device 295. The display unit 290 may be, include, or be part of multiple display units. In some examples, the display unit 290 may include one, or any combination, of a central display unit associated with a dash of the vehicle 105 (e.g., a vehicle head unit), an instrument cluster display unit associated with an instrument cluster of the vehicle 105, and/or a heads-up display unit associated with the dash and a windshield of the vehicle 105; accordingly, as used herein the reference numeral 290 may refer to one, or any combination, of the display units. The I/O device 295 may be, include, or be part of a communication port (e.g., a USB port), a Bluetooth communication interface, a touch-screen display unit, soft keys associated with a dash, a steering wheel, or another component of the vehicle 105, and/or similar components. Other examples of sub-components that may be part of the interface engine 155 include, but are not limited to, audible alarms, visual alerts, telecommunications equipment, and computer-related components, peripherals, and systems.

In some examples, a portable user device 300 may be coupled to, and adapted to be in communication with, the interface engine 155. For example, the portable user device 300 may be coupled to, and adapted to be in communication with, the interface engine 155 via the 1/0 device 295 (e.g., the USB port and/or the Bluetooth communication interface). In an example, the portable user device 300 is a handheld or otherwise portable device (e.g., a smartphone or tablet computer) which is carried onto the vehicle 105 by a user who is a driver or a passenger on the vehicle 105, or proximate to the vehicle. In addition, or instead, the portable user device 300 may be removably connectable to the vehicle 105, such as by temporarily attaching the portable user device 300 to the dash, a center console, a seatback, or another surface in the vehicle 105. In another example, the portable user device 300 may be permanently installed in the vehicle 105. In some examples, the portable user device 300 is, includes, or is part of one or more computing devices such as personal computers, personal digital assistants, cellular devices, mobile telephones, wireless devices, handheld devices, laptops, audio devices, tablet computers, game consoles, cameras, and/or any other suitable devices. In several examples, the portable user device 300 is a smartphone such as, for example, an iPhone® by Apple Incorporated. In other examples, the portable device is, or serves as, an electronic key fob.

The vehicle head unit client 100 also includes TLS authentication module 142, the operation of which will be described below. In some embodiments, the TLS authentication module 142 comprises a standalone housing with its own processor and memory. In other embodiments, the TLS authentication module 142 exists as software, firmware, or hardware within another processor, such as the vehicle head unit or display unit 290, vehicle control unit 110, operational equipment engine 140, or power train ECU 113. The sensor engine 150 includes environmental sensors 201 and vehicle sensors 202.

A reader of ordinary skill in the art will understand that other components or arrangements of components may be found in a vehicle 105, and that the same general principles apply to electric vehicles, internal combustion vehicles, and hybrid vehicles.

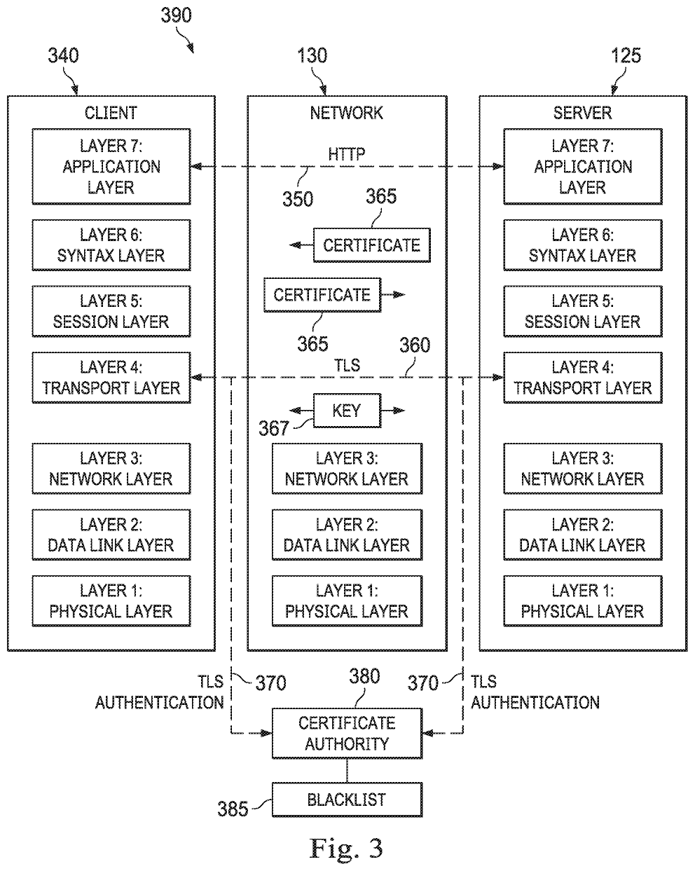

FIG. 3 is a diagrammatic illustration of a client-server architecture 390 that permits a client 340 to communicate securely with a server 125 over a network 130, according to aspects of the present disclosure. In some examples, the client system 340 may be in a different geographic location than the server 125, and the network 130 may be a wireless network 130, or may include one or more wireless links and or wired links, as will be understood by a person or ordinary skill in the art, such that the physical distance between the client system 340 and the server system 125, and the network pathways 130 required to link them together, are “hidden” or “abstracted”.

The Open Systems Interconnection (OSI) model of network communication involves 7 layers: an Application Layer 7, a Presentation Layer or Syntax Layer 6, a Session Layer 5, a Transport Layer 4, a Network Layer 3, a Data Link Layer 2, and a Physical Layer 1. In some examples, the layers perform as described below. Application Layer 7 includes, logic operations, user interfaces, user authentication, file transfers, and other software operations, many of which may be user-facing. The Presentation Layer or Syntax Layer 6 handles data formatting such as encryption and decryption of secure message traffic, etc. The Session Layer 5 manages connections between different applications operating on the client system 340 and/or server system 125. The Transport Layer 4 manages data transfer between systems, such as the client system 340 and the server system 125. The Network Layer 3 performs switching and routing operations to form and maintain logic paths between systems, such as client system 340 and server system 125. The Data Link Layer 2 handles encoding and decoding of bits or bytes into data packets. The Physical Layer 1 includes physical and electrical hardware, such as computer processors, memory, network hardware, and wiring.

One purpose of these 7 layers is to abstract or “hide” different processes so that, for example, software running on the Application Layer 7 of the client system 340 can exchange message traffic 350 (e.g., Hypertext Transfer Protocol or HTTP get and put operations) with processes running on the Application Layer 7 of the server system 125, without having to be aware of the complex operations and devices (both hardware and software) required to transport these messages 350 securely and privately from one system to another.

A vehicle or other computing system may include a client 340 that communicates over a network 130 with a remote server 125, to access services (e.g., navigation, concierge, or e-commerce services). The client may for example include web-browser-like functionality operating at an Application Layer 7 on (or accessible through) a head unit (HU) 290, and exchanging HTTP traffic 350 with web-server-like functionality operating at an Application Layer 7 of a remote server 125. Networks (including but not limited to vehicle networks) can implement a method referred to as Online Certificate Status Protocol (OCSP) to enable clients 340 and servers 125 to authenticate one another. With OSCP, communications may be secured by an encrypted two-way communication link using a Transport Layer Security (TLS) session 360 operating at Transport Layer 4. TLS helps protect both the client 340 and the server 125 from attack by rogue agents, by ensuring that each side is communicating with a valid entity rather than, for example, a “man in the middle” attacker with stolen credentials. The client's right to access secure services via TLS may be validated at the time of initialization by the exchange of digital certificates 365—one certificate 365 associated with the vehicle and a second certificate 365 associated with the server. With OSCP, the client validates the server's certificate 365 by sending certificate information 370 (e.g., the certificate's serial number) to a third-party certifying authority (CA) 380, which checks the certificate information 370 against a current Certificate Revocation List (CRL) or “blacklist” 385 of revoked certificates.

A certificate 365 may be issued for example by an equipment manufacturer (e.g., a vehicle manufacturer) with a specified expiration date. Once the expiration date has passed, the CA 380 will mark the certificate 365 as “revoked,” and will accordingly include an entry in the blacklist 385 to indicate the certificate's revoked status. Certificates 365 may also be revoked if they are suspected of being compromised (e.g., by a hacker or rogue agent). In the case of client certificates 365 associated with a vehicle, the certificate 365 may additionally be revoked if, for example, the vehicle is wrecked, stolen, recalled, has a bad software load, is in need of a software update, or attempts to connect with a foreign network (e.g., a network 130 in a country for which the client 340 is not authorized to communicate with the server 125).The server 125 validates the certificate 365 of the client 340 by the same process, and either side may refuse the connection if the other side's certificate 365 is reported by the CA 380 as revoked. Once both certificates 365 have been confirmed as valid (i.e., not revoked) by the CA 380, the client 340 and server 125 exchange a mutual encryption key 367, and can then begin exchanging encrypted data. In a client-server architecture, this “handshake” process may occur at the Transport Layer 4 on both the client side 340 and the server side 125, to establish a TLS session 360 between the client 340 and the server 125.

Once the TLS session 360 has been established, processes operating on the Application Layer 7 of the client system 340 can begin exchanging encrypted messages 350 (e.g., HTTP messages, as with a web browser and a web server) with processes operating on the Application Layer 7 of the server system 125. Although this message traffic 350 may actually involve devices, modules, signals, or operations at each of the layers beneath the Application Layer 7 (e.g., Layers 1-6), such devices, modules, signals, or operations are abstracted or hidden from the processes running at the Application Layer 7, such that the Application Layer 7 of the client 340 “feels” as though it is communicating directly with the Application Layer 7 of the server 125, and vice-versa.

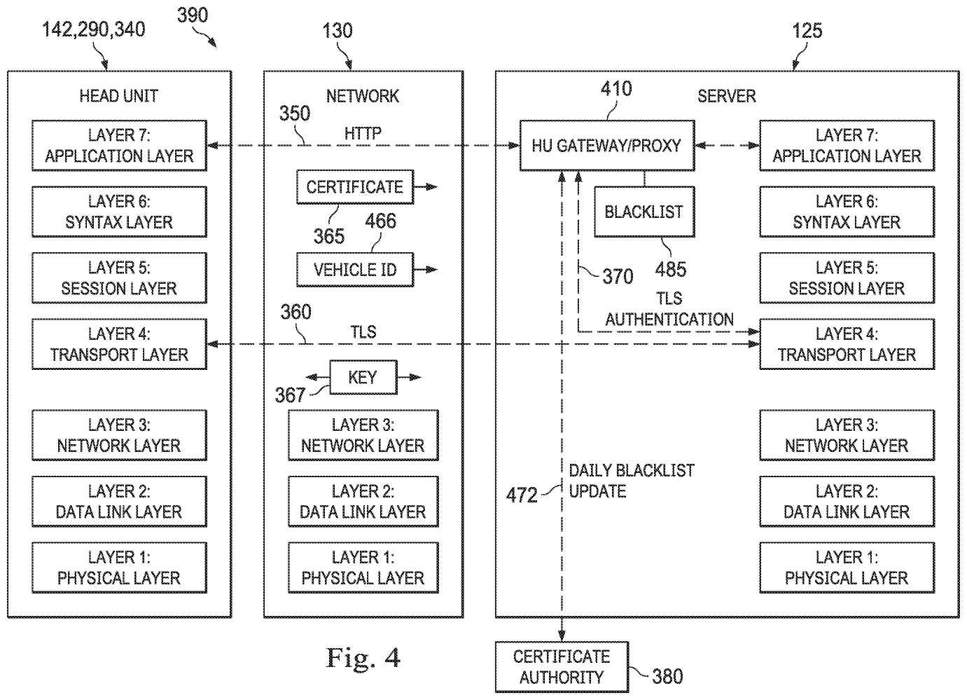

FIG. 4 is a diagrammatic illustration of a client-server architecture 390 that permits a client 340 to communicate securely with a server 125 over a network 130, using a head unit gateway 410, in accordance with at least one embodiment of the present disclosure. The head unit gateway or head unit proxy server 410 may for example be a process or module that runs on the Application Layer 7 of the server 125, and provides real-time authentication of a digital certificate 365 associated with the vehicle. A TLS authentication module 142, running on or communicating through a head unit 290 (which is acting as a network client 340), sends its certificate 365 and vehicle ID 466 to the head unit gateway 410 as a header (e.g., an HTTP header), and the head unit gateway 410 checks the certificate 365 (or related data such as the certificate's serial number) and the vehicle ID 466 against a locally maintained blacklist 485. This locally maintained blacklist 485 may for example receive regular (e.g., daily) updates or refreshes 472 from the CA 380. The head unit gateway 410 then sends a TLS authentication confirmation 370 to the Transport Layer 4 of the server. The Transport Layers 4 of the head unit 290 and the server 130 then exchange a mutual encryption key 367 to establish a TLS session 360 that permits secure, encrypted communication between the head unit 290 and the server 125. This simplified handshake process permits the server 125 to validate the head unit 290, to reject connections from rogue certificates 365, and to form valid TLS connections 360 with the head unit 290, without requiring the server 125 to make real-time contact with the CA 380. It also permits the server 125 to reject a TLS session 360 with a HU 290 based on the vehicle ID 466 instead of, or in additional to, rejecting the TLS session 360 based on the certificate 365 (or information relating to the certificate, such as the certificate serial number).

This hybrid Layer 4/Layer 7 approach to vehicle network security permits the server 125 to validate whether a particular head unit 290, associated with a particular vehicle ID 466, is authorized to access remote vehicle services. Unlike OSCP, this modified approach takes certificate validation out of Transport Layer 4 (where the TLS session 360 occurs), and moves it instead to Application Layer 7. In this way, client certificates 365 can be validated directly by the head unit gateway 410, or by another system or repository to which the head unit gateway 410 has delegated or abstracted this task. The head unit gateway 410 thus does not rely on the Transport Layer 4 for validation of a vehicle's certificate 365 or vehicle ID 466.

If the head unit gateway 410 determines the certificate 365 (or associated information such as the certificate's serial number) or vehicle ID 466 is invalid (i.e., included on the blacklist 485), the head unit gateway 410 terminates the Layer 4 connection (i.e., the TLS session) and prevents the head unit 290 associated with that vehicle ID 466 from accessing remote vehicle services (e.g., navigation, concierge, e-commerce, etc.). In some embodiments, this prevents a head unit 290 from proceeding to access server functions due to its invalid certificate 365, and minimizes the exposure of the server 125 (or the services provided by the server 125) to malicious activities. In some embodiments, moving certificate validation to the head unit gateway 410 eliminates overhead associated with real-time OCSP revocation checks and/or improves TLS session establishments.

In some embodiments, the blacklist 485 may be encrypted. In some embodiments, the head unit gateway 410 may be activated upon the head unit 290 receiving a push notification from the server that includes valid certificate information. A reader of ordinary skill in the art will appreciate that there may be a separate process (not shown in FIG. 4), by which the client 340 validates a certificate sent by the server 125.

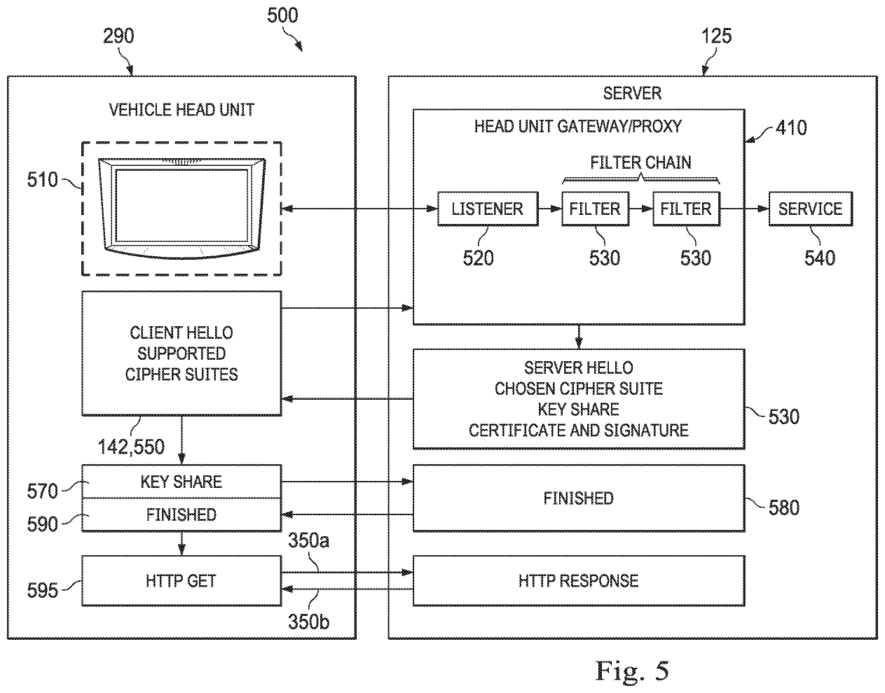

FIG. 5 is a diagrammatic illustration, in block diagram form, of a handshake process 500 between a vehicle head unit 290 and a server 125 that includes a head unit gateway or head unit proxy 410 in accordance with at least one embodiment of the present disclosure. The head unit 290 includes a touch screen 510 that permits a user to navigate through different options or menus, some of which may permit the user to request services 540 from the remote server 125. The head unit gateway 410, running on the server 125, includes a listener 520 and a chain of filters 530, the operation of which will be described below. Based on the results of the handshake process 500, the head unit gateway 410 either allows or blocks access (e.g., two-way HTTP message traffic) between the head unit 290 and one or more services 540.

A first step 550 of the handshake process 500 (performed for example by a TLS authentication module 142 associated with the head unit 290) involves the head unit 290 sending a “client hello” message which may include for example a digital certificate (or related information such as the certificate serial number), and a list of supported cipher suites for encrypting HTTP traffic. Other information supplied in this step may include proprietary user information, passwords, biometrics, hashed data, vehicle ID or serial number, or head unit ID or serial number.

Once the certificate information has been validated by the head unit gateway 410 (as shown for example in FIG. 4), a next step 560 in the handshake process occurs when the server 125 sends back to the head unit 290 a series of messages, which may include for example a “server hello” message, a chosen cipher suite for encrypting HTTP traffic, a shared encryption key, a digital certificate, and a signature.

In step 570, the head unit 290 sends the shared encryption key back to the server 125 as a verification.

In step 580, the server 125 informs the head unit 290 that the handshake process 500 is finished.

In step 590, the head unit 290 registers the handshake process 500 as finished.

In step 595, the head unit 290 and server 125 begin exchanging message traffic, including for example HTTP get messages 350a and HTTP put messages 350b, that enable the head unit 290 to make use of the service 540.

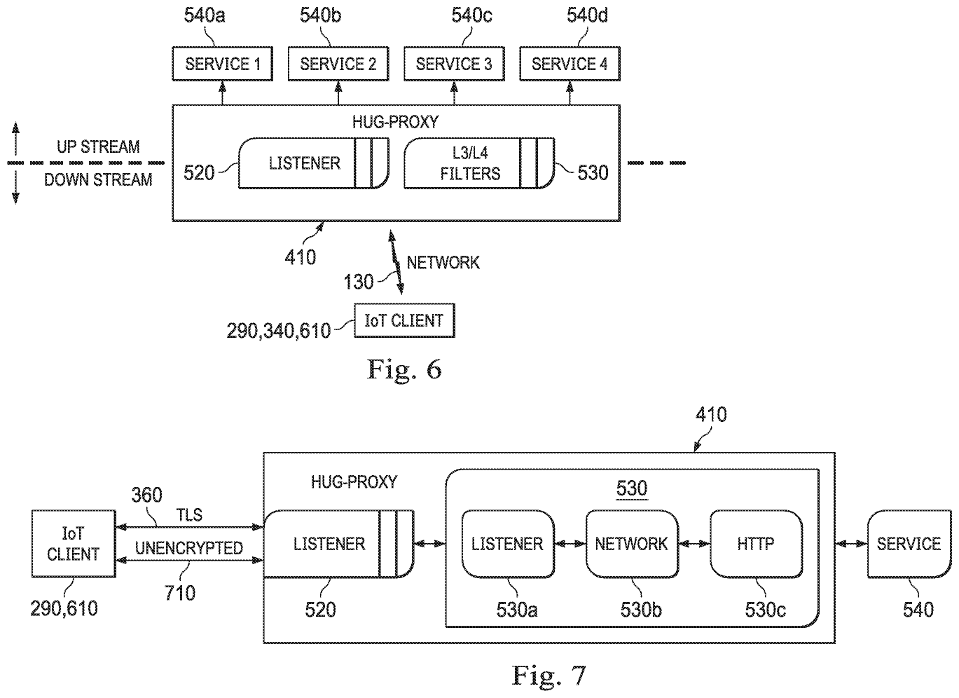

FIG. 6 is a diagrammatic illustration of communication between a head unit 290 and a plurality of services 540a, 540b, 540c, and 540d, in accordance with at least one embodiment of the present disclosure. In the example shown in FIG. 6, the head unit 290 is (or executes, or supports communication with) an Internet of Things (IoT) client 610, which serves as the network client 340 (as shown for example in FIG. 4). An IoT client 610 may for example be a limited type of client 340 that includes sockets for basic client-server network connectivity but is not configured for OSCP. The IoT client 610 sends message traffic (e.g., HTTP get and put operations) upstream (e.g., toward the services) over the network 130, and receives downstream (e.g., toward the client) message traffic (e.g., HTTP get and put operations). This message traffic is intercepted by the head unit gateway or head unit proxy 410. Within the head unit gateway 410, a listener 520 reads incoming messages (e.g., messages traveling upstream, from the IoT client toward the services) to determine whether the messages include headers that contain certificate data which can be used to initiate a TLS session as shown above in FIG. 4. In some embodiments, the head unit gateway 410 includes filters 530 that monitor network traffic on the Transport Layer 4 and the Network Layer 3 so that, for example, unencrypted HTTP messages are rejected and are not passed on to the services 540a-540d, whereas encrypted HTTP messages that are part of an established TLS session are passed onward to the appropriate service or services, selected from 540a-540d.

In an example, services 540a-540d are separate from one another, so that (for example) the IoT client 610 may communicate with one service 540a (e.g., exchanging position, mapping, and routing data back and forth with a navigation service) separately from another service 540b (e.g., exchanging human voice traffic back and forth with a concierge service). In some cases, the IoT client 610 may communicate with two or more different services (e.g., service 540a and service 540b) simultaneously, either through the same TLS session or through two parallel TLS sessions.

FIG. 7 is a diagrammatic illustration of communication between a head unit 290 and a service 540, in accordance with at least one embodiment of the present disclosure. In the example shown in FIG. 7, the head unit 290 is (or executes, or communicates with) an IoT client 610. The IoT client 610 can communicate with a head unit gateway or head unit proxy 410 through a TLS session 360 and/or an unencrypted data channel. The head unit gateway 410 includes a listener 520, which examines incoming message traffic and passes it along to a filter chain 530. In the example shown in FIG. 7, the filter chain 530, includes a listener filter 530a, a network filter 530b and an HTTP filter 530c.

In an example, the listener filter 530a examines incoming TLS traffic 360 and unencrypted traffic 710. Properly formatted message traffic in an established TLS session 360 is passed along to the service 540. Unencrypted message traffic 710 is passed along to the filter chain 530. When a new connection is received on a head unit gateway listener, Listeners are configured with TLS Inspector Listener Filter 530a. This TLS Inspector listener filter 530a detects whether the transport appears to be TLS or plaintext, and if it is TLS, it detects the Server Name Indication and/or Application-Layer Protocol Negotiation from the client. This can be used to select appropriate filter chain (Filter chain match criteria) the configured connection local filter stack is instantiated and begins processing subsequent events. A filter chain 530 is composed of one or more network level (L3/L4) filters. The listener filter 530a examines the unencrypted message traffic 710 to determine if its headers contain metadata (e.g., digital certificate information and/or vehicle ID information) that can be used to establish a TLS session 360. If unencrypted traffic 710 does not include metadata that is relevant for TLS authentication, the traffic is rejected (e.g., not passed along to subsequent filters, or to the services). If the unencrypted traffic does contain TLS authentication metadata, the metadata is passed to the network filter 530b. The network filter 530b authenticates the metadata (e.g., digital certificate information and/or vehicle ID information) as shown for example in FIG. 4. The HTTP filter 530c will truncate the connection if the IoT client's certificate is not valid (e.g., if its serial number is found on a blacklist of revoked certificates). If the certificate is valid, the HTTP filter 530c will permit the Transport Layer 4 to establish the TLS session 360. The HTTP filter 530c supports external authorization filter which can leverage another HTTP/REST service or other to check whether an incoming HTTP request is authorized or not. If the request is deemed unauthorized, then the request will be denied normally with, for example, a 403 (Forbidden) response.

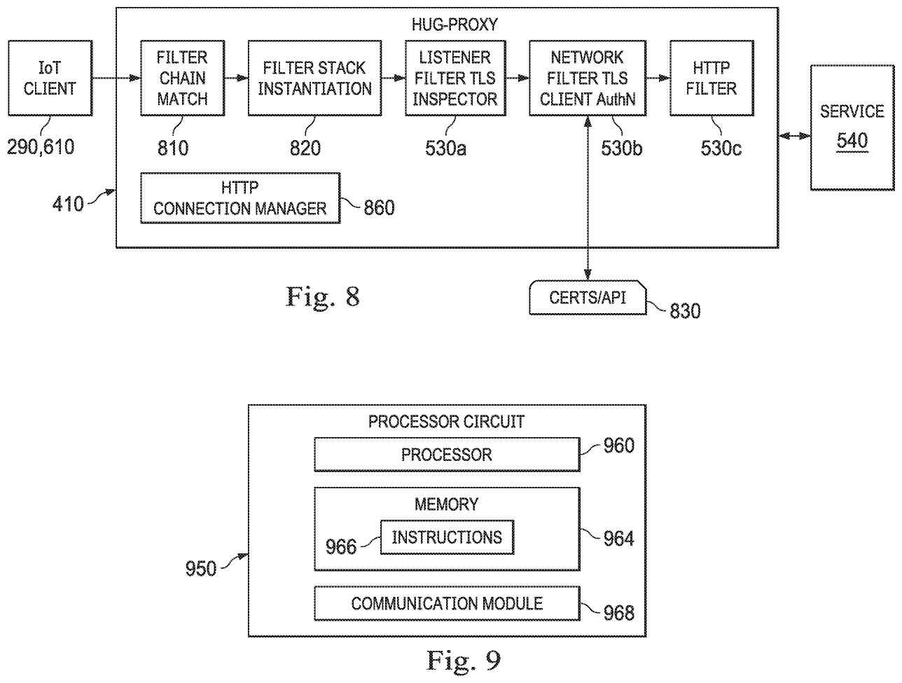

FIG. 8 is a diagrammatic illustration of communication between a head unit 290 and a service 540, in accordance with at least one embodiment of the present disclosure. In the example shown in FIG. 8, the head unit 290 is (or executes, or communicates with) an IoT client 610. The IoT client 610 can communicate with the head unit gateway (or head unit proxy, or envoy proxy) 410. When message traffic arrives at the head unit gateway 410, the head unit gateway performs a filter chain match 810, which requires a filter stack instantiation 820, which brings the listener filter 530a, network filter 530b, and HTTP filter 530c into existence.

The listener filter or TLS inspector 530 then prepares to validate the revocation status of the certificate. The network filter 530b performs TLS client authorization, by passing certificate or vehicle ID information to a certification application program interface 830 that may, for example, check the information against a blacklist of revoked certificates or vehicle IDs. Based on the cert status, the connectivity is either permissive or non-permissive. In other words, if the certificate is valid (e.g., not included on the blacklist of revoked credentials), the HTTP filter will permit the Transport Layer 4 to establish the TLS session 360. In other words, the network filter 530b in the chain performs TLS client authentication via principals list fetched, for example, from a REST API service. This filter matches the presented client certificate hash (digest) against the principal (sha_256 digest list) list to determine whether the connection should be allowed or not. The system may in some instances specify or keep track of the number of connections allowed by the filter if the digest match happens, and/or the number of connections denied if the digest doesn't match.

Depending on the implementation, the head unit gateway 410 may also include an HTTP connection manager 860. In an example, the HTTP connection manager 860 translates raw bytes into HTTP level messages and events (e.g., headers received, body data received, trailers received, etc.). It may also handle functionality common to all HTTP connections and requests such as access logging, request ID generation and tracing, request/response header manipulation, route table management, and statistics. This filter can be used for example to validate the Vehicle ID in the header for additional validation.

FIG. 9 is a schematic diagram of a processor circuit 950, according to embodiments of the present disclosure. The processor circuit 950 may be implemented in the head unit/display unit 290, VCU 110, or portable device 300 of FIG. 2, or other devices or workstations (e.g., third-party workstations, network routers, etc.), or on a cloud processor or other remote processing unit (e.g., a server), as necessary to implement the method. As shown, the processor circuit 950 may include a processor 960, a memory 964, and a communication module 968. These elements may be in direct or indirect communication with each other, for example via one or more buses.

The processor 960 may include a central processing unit (CPU), a digital signal processor (DSP), an ASIC, a controller, or any combination of general-purpose computing devices, reduced instruction set computing (RISC) devices, application-specific integrated circuits (ASICs), field programmable gate arrays (FPGAs), or other related logic devices, including mechanical and quantum computers. The processor 960 may also comprise another hardware device, a firmware device, or any combination thereof configured to perform the operations described herein. The processor 960 may also be implemented as a combination of computing devices, e.g., a combination of a DSP and a microprocessor, a plurality of microprocessors, one or more microprocessors in conjunction with a DSP core, or any other such configuration.

The memory 964 may include a cache memory (e.g., a cache memory of the processor 960), random access memory (RAM), magnetoresistive RAM (MRAM), read-only memory (ROM), programmable read-only memory (PROM), erasable programmable read only memory (EPROM), electrically erasable programmable read only memory (EEPROM), flash memory, solid state memory device, hard disk drives, other forms of volatile and non-volatile memory, or a combination of different types of memory. In an embodiment, the memory 964 includes a non-transitory computer-readable medium. The memory 964 may store instructions 966. The instructions 966 may include instructions that, when executed by the processor 960, cause the processor 960 to perform the operations described herein. Instructions 966 may also be referred to as code. The terms “instructions” and “code” should be interpreted broadly to include any type of computer-readable statement(s). For example, the terms “instructions” and “code” may refer to one or more programs, routines, sub-routines, functions, procedures, etc. “Instructions” and “code” may include a single computer-readable statement or many computer-readable statements.

The communication module 968 can include any electronic circuitry and/or logic circuitry to facilitate direct or indirect communication of data between the processor circuit 950, and other processors or devices. In that regard, the communication module 968 can be an input/output (I/O) device. In some instances, the communication module 968 facilitates direct or indirect communication between various elements of the processor circuit 950 and/or the vehicle head unit gateway 410. The communication module 968 may communicate within the processor circuit 950 through numerous methods or protocols. Serial communication protocols may include but are not limited to US SPI, I²C, RS-232, RS-485, CAN, Ethernet, ARINC 429, MODBUS, MIL-STD-1553, or any other suitable method or protocol. Parallel protocols include but are not limited to ISA, ATA, SCSI, PCI, IEEE-488, IEEE-1284, and other suitable protocols. Where appropriate, serial and parallel communications may be bridged by a UART, USART, or other appropriate subsystem.

External communication (including but not limited to software updates, firmware updates, preset sharing between the processor and central server, or readings from the system) may be accomplished using any suitable wireless or wired communication technology, e.g., a cable interface such as a USB, micro USB, Lightning, or FireWire interface, Bluetooth, Wi-Fi, ZigBee, Li-Fi, or cellular data connections such as 2G/GSM, 3G/UMTS, 4G/LTE/WiMax, or 5G. For example, a Bluetooth Low Energy (BLE) radio can be used to establish connectivity with a cloud service, for transmission of data, and for receipt of software patches. The controller may be configured to communicate with a remote server, or a local device such as a laptop, tablet, or handheld device, or may include a display capable of showing status variables and other information. Information may also be transferred on physical media such as a USB flash drive or memory stick.

As will be readily appreciated by those having ordinary skill in the art after becoming familiar with the teachings herein, the head unit gateway advantageously permits a server to validate message traffic coming from a vehicle head unit, establish secure connections, and connect the head unit to remote vehicle services (e.g., navigation or concierge services), without having to contact a certification authority in real time. Depending on the implementation, a number of variations are possible on the examples and embodiments described above. For example, the head unit gateway may communicate via a wide variety of messaging or encryption protocols, and may employ other specific certification strategies than those expressly described herein. The technology may be applied to different vehicle types, including on-road and off-road vehicles, watercraft, and aircraft.

The logical operations making up the embodiments of the technology described herein are referred to variously as operations, steps, objects, elements, components, layers, or modules. It should be understood that these may occur or be performed or arranged in any order, unless explicitly claimed otherwise or a specific order is inherently necessitated by the claim language. All directional references e.g., upper, lower, inner, outer, upward, downward, left, right, lateral, front, back, top, bottom, above, below, vertical, horizontal, clockwise, counterclockwise, proximal, and distal are only used for identification purposes to aid the reader's understanding of the claimed subject matter, and do not create limitations, particularly as to the position, orientation, or use of the head unit gateway. Connection references, e.g., attached, coupled, connected, and joined are to be construed broadly and may include intermediate members between a collection of elements and relative movement between elements unless otherwise indicated. As such, connection references do not necessarily imply that two elements are directly connected and in fixed relation to each other. The term “or” shall be interpreted to mean “and/or” rather than “exclusive or.” Unless otherwise noted in the claims, stated values shall be interpreted as illustrative only and shall not be taken to be limiting.

The above specification, examples and data provide a complete description of the structure and use of exemplary embodiments of the head unit gateway as defined in the claims. Although various embodiments of the claimed subject matter have been described above with a certain degree of particularity, or with reference to one or more individual embodiments, those skilled in the art could make numerous alterations to the disclosed embodiments without departing from the spirit or scope of the claimed subject matter.

Still other embodiments are contemplated. It is intended that all matter contained in the above description and shown in the accompanying drawings shall be interpreted as illustrative only of particular embodiments and not limiting. Changes in detail or structure may be made without departing from the basic elements of the subject matter as defined in the following claims.

What is claimed is:

1. A system comprising:
a server including a processor, an application layer, and a transport layer;
a client device associated with a vehicle;
a wireless communication link between the server and the client device;
a credential uniquely associated with the vehicle, wherein the credential is configured to be transmitted by the client device using a communication protocol and received by the server over the wireless communication link;
a gateway process running on the application layer of the server and configured to validate the credential after it is received over the wireless communication link;
an encryption key provided to the client device based at least in part on the validated credential;
a secure communication session established between the server and the client device over the wireless communication link, wherein the secure communication session is established on the transport layer of the server based at least in part on the communication protocol and the encryption key; and
one or more services accessible on the server by the client device over the wireless communication link through the secure communication session.

2. The system of claim 1, wherein the credential comprises a public key encryption certificate.

3. The system of claim 2, wherein the credential further comprises a vehicle ID.

4. The system of claim 1, wherein the communication protocol is a hypertext transmission protocol (HTTP).

5. The system of claim 1, wherein the secure communication session is a transport layer security (TLS) session.

6. The system of claim 1, wherein the client device comprises a head unit of the vehicle.

7. The system of claim 1, wherein validating the credential comprises checking the credential against a list of revoked credentials.

8. The system of claim 7, wherein the list of revoked credentials is stored locally on the server.

9. The system of claim 1, wherein the one or more services comprise at least one of a navigation service, a concierge service, or an e-commerce service.

10. The system of claim 1, further comprising the vehicle.

11. A method comprising:
providing a server including a processor;
establishing a wireless communication link between the server and a client device on a vehicle;
providing a credential uniquely associated with the vehicle;
with the server, receiving the credential from the client device using the wireless communication link and a communication protocol;
with a gateway process running on an application layer of the server, validating the credential after it is received over the wireless communication link;
with the server, providing an encryption key to the client device based at least in part on the validated credential;
a transport layer of the server, establishing a secure communication session between the server and the client device using the wireless communication link, the communication protocol, and the encryption key; and
from the server, supplying one or more services to the client device through the secure communication session.

12. The method of claim 11, wherein the credential comprises a public key encryption certificate.

13. The method of claim 12, wherein the credential further comprises a vehicle ID.

14. The method of claim 11, wherein the communication protocol is a hypertext transmission protocol (HTTP).

15. The method of claim 11, wherein the secure communication session is a transport layer security (TLS) session.

16. The method of claim 11, wherein the client device comprises a head unit of the vehicle.

17. The method of claim 11, wherein validating the credential comprises checking the credential against a list of revoked credentials, wherein the list of revoked credentials is stored locally on the server.

18. The method of claim 11, wherein the one or more services comprise at least one of a navigation service, a concierge service, or an e-commerce service.
